(19) United States
(12) Patent Application Publication
(10) Pub. No.: US 2019/0107662 A1
(43) Pub. Date: Apr. 11, 2019

(54) BACKLIGHT UNITS COMPRISING A THIN LIGHT GUIDE PLATE AND A LIGHT COUPLING UNIT

(71) Applicant: CORNING INCORPORATED, CORNING, NY (US)

(72) Inventors: Adam James Ellison, Corning, NY (US); Shenping Li, Painted Post, NY (US)

(21) Appl. No.: 16/092,116

(22) PCT Filed: Apr. 4, 2017
(86) PCT No.: PCT/US2017/025864

§ 371 Date: Oct. 8, 2018

Related U.S. Application Data
(60) Provisional application No. 62/320,052, filed on Apr. 8, 2016.

(51) Int. Cl. F21V 8/00

(52) U.S. Cl. CPC G02B 6/0028; G02B 6/002; G02B 6/0068

(57) ABSTRACT

Disclosed herein are backlight units comprising a light guide plate (210), a light coupling unit (220) in contact with the light guide plate, and a light source (230) optically coupled to the first and second light incident edge surfaces. The backlight units may also comprise light recycling cavities by forming a reflector (240) on the edge surface (224) of the coupling unit opposing the incidence surface (221). Electronic, display, and lighting devices comprising such BLUs are further disclosed herein.

### CROSS-REFERENCE TO RELATED APPLICATIONS

This application claims the benefit of priority under 35 U.S.C. § 119 of U.S. Provisional Application Ser. No. 62/320052 filed on Apr. 8, 2016, the content of which is relied upon and incorporated herein by reference in its entirety.

### FIELD OF THE DISCLOSURE

The disclosure relates generally to backlight units and display devices comprising such backlight units, and more particularly to backlight units comprising a thin light guide plate and a light coupling unit for increasing optical coupling efficiency.

### BACKGROUND

Liquid crystal displays (LCDs) are commonly used in various electronics, such as cell phones, laptops, electronic tablets, televisions, and computer monitors. Increased demand for thinner, larger, high-resolution flat panel displays drives the need for high-quality substrates for use in the display, e.g., as light guide plates (LGPs). As such, there is a desire in the industry for thinner LGPs with higher light coupling efficiency and/or light output, which may allow for a decrease in the thickness and/or an increase in the screen size of various display devices.

Plastic materials such as polymethylmethacrylate (PMMA) may be used to manufacture LGPs. However, PMMA has a relatively high coefficient of thermal expansion (e.g., approximately one order of magnitude greater than that of glass), which may necessitate a larger space between the light source, e.g., LED, and the light guide when designing an LCD device. This gap can decrease the efficiency of light coupling from the light source to the light guide and/or necessitate a larger bezel to conceal the edges of the display. Moreover, due to its relatively weak mechanical strength, it can be difficult to make light guides from PMMA that are both sufficiently large and thin to meet current consumer demands. PMMA light guides can thus limit the light emitting surface area available to display an image, either due to concealment by a bezel or inability to manufacture sheets large enough for the desired display size.

Glass light guides have been proposed as alternatives to PMMA due to their low light attenuation, low coefficient of thermal expansion, and high mechanical strength at relatively low thicknesses. However, while glass can be used to produce relatively thin LGPs, such LGPs may also have various drawbacks. For instance, reducing the thickness of the LGP may necessitate the use of smaller light sources (e.g., LEDs) to promote efficient optical coupling. Decreasing the size of the light source can, in turn, decrease light output luminance and/or efficiency and/or increase the overall cost of the backlight unit (BLU). It may therefore be desirable from economic and/or design standpoints to use larger light sources even in the case of thinner LGPs. Various efforts have been made to more efficiently couple light injected into an edge-lit LGP by an adjacent light source, particularly as the distance between the light source and the LGP increases. However, coupling apparatuses currently may have one or more drawbacks, such as increased manufacturing expense and/or complexity and/or low effectiveness.

It would therefore be advantageous to provide devices for coupling light from a larger light source into a thinner light guide plate, and to reduce the overall thickness of the display device without sacrificing brightness and/or energy efficiency. It would also be advantageous to provide improved methods and apparatuses for increasing the light coupling efficiency between a light source and a light guide plate that do not substantially increase the cost and/or complexity of manufacture.

### SUMMARY

The disclosure relates, in various embodiments, to backlight units comprising a light guide plate comprising a light emitting major surface, an opposing major surface, and a first light incident edge surface; a light coupling unit comprising a second light incident edge surface, an opposing light reflecting edge surface, a first surface, and an opposing second surface; and a light source optically coupled to the first and second light incident edge surfaces, wherein at least a portion of the first surface of the light coupling unit is in physical contact with at least a portion of the light emitting major surface or opposing major surface of the light guide plate. Also disclosed herein are backlight units comprising a light guide plate comprising a light emitting major surface, an opposing major surface, and a first light incident edge surface; a light coupling unit in physical contact with at least a portion of the light emitting major surface or opposing major surface of the light guide plate, the light coupling unit comprising a second light incident edge surface and an opposing light reflecting edge surface; a light source optically coupled to the first and second light incident edge surfaces; and a light recycling cavity defined by the light reflecting edge surface of the light coupling unit and a reflective film on each of a top, bottom, and back surface of the light source. Electronic, display, and lighting devices comprising such BLUs are further disclosed herein.

In certain embodiments, the light reflecting edge surface of the light coupling unit can comprise a reflective film or coating and/or at least one of the top, bottom, and/or back surfaces of the light source can comprise a reflective film or coating. According to various embodiments, a height of the at least one light source may be less than or equal to a combined thickness of the light guide plate and light coupling unit. The first and second surfaces of the light coupling unit can, in non-limiting embodiments, be parallel with the light emitting major surface of the light guide plate or, in other embodiments, may not be parallel and the second surface may have a tilt angle ranging from −10° to 10°. In a further embodiment, the first light incident edge surface of the light guide plate may be chamfered, e.g., at an angle ranging from about 10° to about 60°.

According to various embodiments, the refractive index of the light guide plate (nₚ) can be different from a refractive index of the light coupling unit (n_{c}), for example, nₚ may be greater than n_{c}, e.g., about 5% to about 20% greater than n_{c}. In certain embodiments, 0.25nₚ+0.77≤n_{c}≤0.25nₚ+1.18. According to further embodiments, a difference between a coefficient of thermal expansion of the light coupling unit and a coefficient of thermal expansion of the light guide plate is less than 30%. In still further embodiments, a modulus of elasticity of at least one of the light guide plate or light coupling unit is less than 5 GPa. According to yet further embodiments, at least one of the light guide plate and the light coupling unit comprises a glass, glass-ceramic, plastic, or polymeric material and/or has an optical transmission of at least about 80% at a visible wavelength ranging from about 420 nm to about 750 nm.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings, wherein, when possible, like numerals refer to like components, it being understood that the appended figures are not necessarily drawn to scale.

FIG. 1 illustrates a backlight unit according to embodiments of the disclosure;

FIG. 2 illustrates a backlight unit according to additional embodiments of the disclosure;

FIG. 3 illustrates a backlight unit according to further embodiments of the disclosure;

FIG. 4A is a plot of optical coupling efficiency for a backlight unit configuration of FIG. 1 as a function of light coupling unit length for embodiments in which the light guide plate and light coupling unit have different refractive indices;

FIG. 4B is a plot of optical coupling efficiency for a backlight unit configuration of FIG. 1 as a function of light coupling unit length for embodiments in which the light guide plate and light coupling unit have the same refractive index;

FIG. 5A is a plot of optical coupling efficiency for a backlight unit configuration of FIG. 1 as a function of the refractive index of the light coupling unit;

FIG. 5B is a plot of optical coupling efficiency for a backlight unit configuration of FIG. 1 as a function of the refractive index of the light coupling unit for light guide plates of varying refractive index;

FIG. 5C is a plot of the difference between the refractive index of the light guide plate and the optimal refractive index of the light coupling unit as a function of the refractive index of the light guide plate;

FIG. 6A is a plot of optical coupling efficiency for a backlight unit configuration of FIG. 2 as a function of light coupling unit length for embodiments in which the light guide plate and light coupling unit have different refractive indices;

FIG. 6B is a plot of optical coupling efficiency for a backlight unit configuration of FIG. 2 as a function of light coupling unit length for embodiments in which the light guide plate and light coupling unit have the same refractive index; and

FIG. 7 is a plot of optical coupling efficiency for a backlight unit configuration of FIG. 3 as a function of the tilt angle of the top surface of the light coupling unit.

### DETAILED DESCRIPTION

Disclosed herein are backlight units comprising a light guide plate comprising a light emitting major surface, an opposing major surface, and a first light incident edge surface; a light coupling unit comprising a second light incident edge surface, an opposing light reflecting edge surface, a first surface, and an opposing second surface; and a light source optically coupled to the first and second light incident edge surfaces, wherein at least a portion of the first surface of the light coupling unit is in physical contact with at least a portion of the light emitting major surface or opposing major surface of the light guide plate. Also disclosed herein are backlight units comprising a light guide plate comprising a light emitting major surface, an opposing major surface, and a first light incident edge surface; a light coupling unit in physical contact with at least a portion of the light emitting major surface or opposing major surface of the light guide plate, the light coupling unit comprising a second light incident edge surface and an opposing light reflecting edge surface; a light source optically coupled to the first and second light incident edge surfaces; and a light recycling cavity defined by the light reflecting edge surface of the light coupling unit and a reflective film on each of a top, bottom, and back surface of the light source. Electronic, display, and lighting devices comprising such BLUs are further disclosed herein.

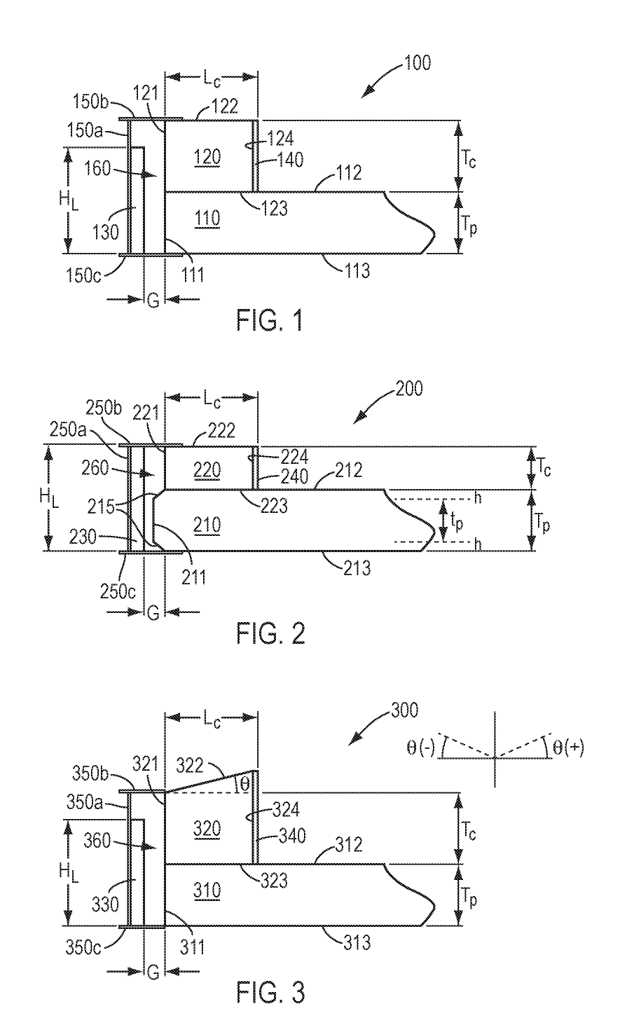

Various embodiments of the disclosure will now be discussed with reference to FIGS. 1-3, which illustrate exemplary BLU configurations. The following general description is intended to provide an overview of the claimed devices, and various aspects will be more specifically discussed throughout the disclosure with reference to the non-limiting embodiments, these embodiments being interchangeable with one another within the context of the disclosure.

FIG. 1 illustrates a backlight unit 100 according to certain aspects of the disclosure. The backlight unit 100 can comprise a light guide plate (LGP) 110, a light coupling unit (LCU) 120, and a light source 130 optically coupled to the LGP and LCU. The LGP 110 can comprise a light incident edge surface 111, a light emitting major surface 112, and an opposing major surface 113 (opposite the light emitting major surface). A thickness T_{P} of the LGP 110 extends between surfaces 112 and 113. Similarly, the LCU 120 can comprise a light incident edge surface 121, a first surface 123, and a second surface 122 (opposite the first surface), as well as an opposing light reflecting edge surface 124 (opposite the light incident edge surface). A thickness T_{C} of the LCU 120 extends between surfaces 122 and 123, and a length L_{C} of the LCU 120 extends between surfaces 121 and 124.

As used herein, the term “optically coupled” is intended to denote that a light source is positioned relative to the LGP so as to introduce or inject light into the LGP. A light source may be optically coupled to a LGP even though it is not in physical contact with the LGP. As shown in FIGS. 1-3, the BLU may be edge-lit, e.g., with a light source positioned adjacent to or abutting an edge of the LGP. When light is injected into the LGP, according to certain embodiments, the light may propagate along the length of the LGP due to total internal reflection (TIR) until it comes into contact with a light extraction feature on the LGP that scatters the light forward toward the user. For example, if the LGP is a glass plate comprising two opposing parallel surfaces defining two opposing air-glass interfaces, light injected into the glass plate can propagate through the glass plate, reflecting alternately between the first and second parallel interfaces unless or until there is a change to the interfacial conditions.

Referring again to FIG. 1, the LGP 110 can have a light incident edge surface 111, a light emitting major surface 112, and an opposing major surface 113. As used herein, a “light incident edge surface” is intended to denote an edge surface optically coupled to an adjacent light source, e.g., an edge of the LGP to which light is injected. A “light emitting major surface” is intended to denote a major surface of the LGP (or BLU) facing an intended user, e.g., a major surface emitting light towards a user. Similarly, an “opposing major surface” is intended to denote the major surface of the LGP (or BLU) opposite the light emitting major surface, which faces away from the user, e.g., towards a rear panel of a device, if present.

One or more components of the backlight unit 100 may be provided with a reflective surface to promote light recycling and further increase light coupling efficiency. For example, the light reflecting edge surface 124 of the LCU may reflect light incident on its surface, for instance, using a reflective film or coating 140 or any other device or composition capable of reflecting light. One or more surfaces of the light source 130 may also comprise a reflecting film or coating, e.g., one or more films 150a, 150b, and/or 150c, which may be positioned in contact with a top surface, back surface, or bottom surface of the light source 130, respectively.

In some embodiments, as depicted in FIG. 1, each film 150a, 150b, and 150c may be present and positioned, together with reflective film 140, to form a light recycling cavity 160. For instance, top reflective film 150b may be in physical contact with the LCU 120, e.g., second surface 122, and bottom reflective film 150c may be in physical contact with LGP 110, e.g., opposing major surface 113, thereby forming light recycling cavity 160 in which light that is not directly injected into the LGP can reflect until it is ultimately redirected into the LGP. The light recycling cavity 160 may, in some embodiments, cover the gap G between the light source 130 and the LGP 110.

With reference to FIG. 2, another exemplary backlight unit 200 may include a LGP 210 with a chamfered light incident edge surface. For example, a chamfer 215 may be provided at the juncture of the light incident edge surface 211 and light emitting major surface 212 of the LGP 210 and/or at the juncture of the light incident edge surface 211 and opposing major surface 213. Such chamfers 215 can have a height h. An exemplary height h for the chamfer 215 can be at least about 5% of the thickness T_{P} of the light guide plate 210, such as ranging from about 0.05*T_{P} to about 0.3*T_{P}, or from about 0.1*T_{P} to about 0.2*T_{P}. For example, in the case of a 0.7 mm thick glass sheet, chamfers having a height of about 0.07 mm or greater can be used at one or both corners of the light incident edge surface 211, or for 1.1 mm thick glass sheet, chamfers having a height of about 0.1 mm or greater can be used. The chamfers 215 can be cut at any suitable angle, for example, ranging from about 10° to about 60°, such as from about 20° to about 50°, from about 30° to about 40°, or about 45°. After chamfering, a non-chamfered portion of the light incident edge surface 211 may have a thickness tₚ, which can range, for example, from about 0.1 mm to about 2.5 mm, such as from about 0.3 mm to about 2 mm, or from about 0.5 mm to about 1 mm, including all ranges and subranges therebetween.

Similar to FIG. 1, the backlight unit 200 of FIG. 2 can comprise a LGP 210, a LCU 220, and a light source 230 optically coupled to the LGP and LCU. The LGP 210 can comprise a light incident edge surface 211, a light emitting major surface 212 (opposite the light emitting major surface), and an opposing major surface 213. The LCU 220 can comprise a light incident edge surface 221, a first surface 223, and an opposing second surface 222 (opposite the first surface), as well as an opposing light reflecting edge surface 224 (opposite the light incident edge surface), which may be provided with a reflective film or coating 240. One or more surfaces of the light source 230 may also comprise a reflecting film or coating, e.g., one or more films 250a, 250b, and/or 250c, which can be positioned to form a light recycling cavity 260.

With reference to FIG. 3, a further exemplary backlight unit 300 may include a LCU 320 with non-parallel surfaces 322 and 323. For example, first surface 323, which is in contact with LGP 310 may be parallel to the light emitting major surface 312 of the LGP 310, while second surface 322 may not be parallel to the light emitting major surface 312. Similarly, second surface 322 of the LCU 320 may be orthogonal to the light incident edge surface 321 of the LCU 320 or may have an angle other than 90° with respect to this surface. In some embodiments, the second surface 322 may be tilted at an angle relative to a normal (dashed line in FIG. 3) to the light incident edge surface 321.

The angle of the second surface 322 with respect to the normal is referred to herein as the “tilt angle” (θ). The tilt angle θ of the second surface 322 with the normal can range, in some embodiments, from about −10° to about 10°, such as from about −8° to about 8°, from about −6° to about 6°, from about −5° to about 5°, from about −4° to about 4°, from about −3° to about 3°, from about −2° to about 2°, from about −1° to about 1°, or 0°, including all ranges and subranges therebetween.

As shown in FIG. 3, a positive tilt angle indicates that the thickness of the LCU 320 increases as a function of distance from the light source 330 (as depicted in FIG. 3), whereas a negative tilt angle indicates that the thickness of the LCU 320 decreases as a function of distance from the light source 330 (not depicted in FIG. 3). Stated otherwise, a positive θ indicates that the second surface 322 and light incident edge surface 321 of the LCU 320 form an angle greater than 90°, whereas a negative θ indicates an angle less than 90° at this juncture.

With general reference to each of FIGS. 1-3, a light source (130, 230, 330), such as an LED, can be optically coupled to a light incident edge surface of the LGP and/or LCU, e.g., adjacent to or abutting the surface(s). The light source may inject light into the LGP and/or LCU, such as blue, UV, or near-UV light having a wavelength ranging from about 100 nm to about 400 nm. According to non-limiting embodiments, the distance between the LGP and the light source (denoted by gap G) can range, for example, from about 0.01 mm to about 2 mm, such as from about 0.04 mm to about 1.8 mm, from about 0.5 mm to about 1.5 mm, from about 0.6 mm to about 1.2 mm, or from about 0.8 mm to about 1 mm, including all ranges and subranges therebetween.

The light source can also have a height H_{L}, which may, in some embodiments, be greater than a thickness T_{P} of the LGP. For example, H_{L} may be at least about 10% greater than T_{P}, such as ranging from about 1.1*T_{P} to about 2*T_{P}, from about 1.2*T_{P} to about 1.9*T_{P}, from about 1.3*T_{P} to about 1.8*T_{P}, from about 1.4*T_{P} to about 1.7*T_{P}, or from about 1.5*T_{P} to about 1.6*T_{P}. Of course, the light source may have any other height relative to the LGP, including heights less than the thickness of the LGP, as appropriate for a desired configuration. In additional embodiments, the thickness of the LGP and/or LCU may be chosen such that T_{C}+T_{P}≥H_{L}. For instance, as shown in FIG. 1, T_{C}+T_{P}>H_{L} or, as shown in FIG. 2, T_{C}+T_{P}≈H_{L}. It is to be understood that the height H_{L}, or any other dimension of the light source, refers herein to the active area of the light source, e.g., the area that emits light (as opposed to the area subtended by a case holding the light source).

According to certain embodiments, the thickness of the LGP, T_{P}, and/or the thickness of the LCU, T_{C}, can be less than or equal to about 3 mm, for example, ranging from about 0.1 mm to about 2 mm, from about 0.3 mm to about 1.5 mm, from about 0.5 mm to about 1.1 mm, or from about 0.7 mm to about 1 mm, including all ranges and subranges therebetween. In some embodiments, the length of the LCU, L_{C}, can be less than a length of the LGP. For instance, it may be desirable to decrease the length of the LCU such that it is not visible in a device comprising the BLU, e.g., it can be concealed behind a bezel or otherwise hidden from the user's view. Furthermore, it may be desirable to decrease the length of the LCU to limit coupling of light back into the LCU from the LGP.

Light injected into the LCU by the light source can couple into the LGP by way of physical contact (e.g., between the first surface of the LCU and the light emitting major surface of the LGP). However, at longer LCU lengths, the potential for light to couple back into the LCU from the LGP increases. As such, in various non-limiting embodiments, a length of the LCU, L_{C}, may be less than 5mm, such as ranging from about 0.3 mm to about 3 mm, from about 0.5 mm to about 2.5 mm, from about 0.8 mm to about 2 mm, from about 1 mm to about 1.8 mm, from about 1.2 mm to about 1.6 mm, or from about 1.4 mm to about 1.5 mm, including all ranges and subranges therebetween. A ratio of LCU length to LGP length may range, in some embodiments from about 1:100 to about 1:2, from about 1:50 to about 1:3, from about 1:20 to about 1:4, or from about 1:10 to about 1:5, including all ranges and subranges therebetween. Alternatively, a ratio of LCU length to LCU height may range from about 20:1 to about 1:1, from about 15:1 to about 2:1, from about 10:1 to about 3:1, or from about 5:1 to about 4:1, including all ranges and subranges therebetween.

As shown in FIGS. 1 and 3, the light incident edge surface (111, 311) of the LGP (110, 310) and the light incident edge surface (121, 321) of the LCU (120, 320) may be aligned to create a combined linear light incident edge surface, e.g., the light incident edge surfaces may be flush and/or parallel with each other. However, in other embodiments, the light incident edge surface of the LCU may not be flush with the light incident edge surface of the LGP. For example, the light incident edge surface of the LCU may be closer to or further away from the light source as compared to the LGP. For instance, as shown in FIG. 2, the LCU 220 may be positioned at a greater distance from the light source 230 as compared to the LGP 210. In the case of a chamfered LGP, as shown in FIG. 2, the light incident edge surface 211 of the LCU 220 may be aligned with the edge of the chamfer 215, rather than the edge of the LGP 210.

The surfaces of the LGP and/or LCU may, in certain embodiments, be planar or substantially planar, e.g., substantially flat. The light emitting major surface and opposing major surface of the LGP may, in various embodiments, be parallel or substantially parallel. Similarly, the first and second surfaces of the LCU may be parallel or substantially parallel. By way of a non-limiting example, the LGP and/or LCU may comprise a rectangular or square sheet having four edges, although other shapes and configurations, including surfaces having one or more curvilinear portions, are envisioned and are intended to fall within the scope of the disclosure. In some embodiments, a rectangular glass or plastic LGP may be coupled to a rectangular LCU waveguide. In further embodiments, as depicted in FIG. 3, the first and second surfaces of the LCU may not be parallel, and the second surface may incline or decline at a tilt angle, θ.

BLUs disclosed herein may have improved light coupling efficiency as compared to similar BLUs not comprising an LCU. For example, light coupling efficiency may be as high as 95%, such as ranging from about 65% to about 90%, from about 70% to about 85%, or from about 75% to about 80%, including all ranges and subranges therebetween. As previously discussed, the LCU may comprise a reflecting edge surface (124, 224, 324) opposite the light incident edge surface, which may be coated with a reflective film or coating (140, 240, 340). In some embodiments, the second surface may also be coated with a reflective film. However, in other embodiments, such a reflective film may not be present, as the majority of the light incident upon the second surface of the LCU will likely be confined in the LCU due to TIR.

Light coupling efficiency can be further enhanced, in some embodiments, by including a reflective film or coating on one or more surfaces of the light source (130, 230, 240), e.g., on the back surface (film 150a, 250a, 350a), top surface (film 150b, 250b, 350b), and/or bottom surface (film 150c, 250c, 350c) to form a recycle cavity (160, 260, 360). It is noted that the front or light emitting surface of the light source may be sufficiently reflective (at visible wavelengths, ˜420-750 nm) without the presence of a film, e.g., at least 50% reflective, such as at least 60% reflective, or at least 70% reflective, including all ranges and subranges therebetween.

Suitable reflective films and coatings may include, for instance, reflective tapes such as diffuse (Lambertian) reflector films or enhanced specular reflector (ESR) films commercially available from WhiteOptics (e.g., White98™), 3M (e.g., Vikuiti™), and Labsphere (e.g., Spectralon®, Spectraflect®, or Permaflect) or metallic films, such as aluminum, gold, silver, copper, platinum, and the like. In certain embodiments, the reflective film on the LCU may be a specular reflector, whereas the reflective film(s) on the light source may be Lambertian reflectors. The reflectivity of any of these films (at visible wavelengths, ˜420-750 nm) may vary as desired for a particular application and can range, for example, from greater than 50% to greater than 98%, such as from 60% to 99%, from 70% to 96%, or from 80% to 90%, including all ranges and subranges therebetween.

Light coupling efficiency may also be affected by the refractive index of the LGP and/or LCU. According to various embodiments, the LGP and/or LCU may have a refractive index ranging from about 1.3 to about 1.8, such as from about 1.35 to about 1.7, from about 1.4 to about 1.65, from about 1.45 to about 1.6, or from about 1.5 to about 1.55, including all ranges and subranges therebetween. In some embodiments, the refractive index of the LCU may be substantially similar to (e.g., within 5% of) the index of refraction of the LGP. In other embodiments, the refractive index of the LCU may be less than that of the LGP. For instance, n_{c} can be less than 0.95*nₚ, such as 0.85*nₚ, 0.8*nₚ, 0.75*nₚ, or 0.70*nₚ, including all ranges and subranges therebetween. According to certain embodiments, n_{c} can be greater than nₚ, e.g., less than or equal to 1.1*nₚ, or less than or equal to 1.05*nₚ. In various non-limiting embodiments, a relationship between n_{c} and nₚ can be expressed as: 0.25nₚ+0.77≤n_{c}≤0.25nₚ+1.18, or 0.25nₚ+0.82≤n_{c}0.25n_{LGP}+1.12, or 0.25nₚ+0.87≤n_{c}0.25nₚ+1.08, or 0.25nₚ+0.92≤n_{c}0.25nₚ+1.02.

According to various embodiments, the materials of construction for the LGP and/or LCU may be chosen to withstand various working conditions during continuous operation, such as the heat and/or light emitted by the light source, without exhibiting aging effects such as discoloration, deformation, cracking, and/or delamination. As the gap between the light source and the LGP decreases, the ability to withstand heat may become more important. Alternatively, it may be possible to increase the gap between the light source and the LGP by utilizing an LGP and LCU that have a combined thickness in excess of the height of the light source (e.g., if T_{P}+T_{C}>>H_{L}).

While improved coupling efficiency can be obtained by decreasing the gap between the light source and the LGP, the temperature changes associated with the proximity of the light source can be significant, e.g., as high as 20-40° C. It may therefore be desirable to choose LGP and/or LCU materials with the same or similar coefficient of thermal expansion (CTE) and/or modulus of elasticity. For instance, if the CTE of the LCU (CTE_{C}) greatly differs from the CTE of the LGP (CTE_{P}), stress at the interface of the two materials may be generated due to elevated temperatures during operation of the BLU. In particular, a large CTE mismatch combined with a high elastic modulus could result in stress that may exceed the adhesive forces holding the LCU and LGP together or, if this does not occur, the stress may produce out of plane bending that might interfere with light coupling. It may therefore be desirable to choose the materials of construction for the LGP and/or LCU such that there is a sufficient CTE match between the LCU and LGP, or to choose at least one material that has an elastic modulus lower than that of the other material such that it produces an easily managed level of stress during operation. In some embodiments, the LGP and LCU may be chosen such that their CTEs are within 30% of one another, e.g., 0.7*CTE_{P}≤CTE_{C}≤1.3*CTE_{P}, or 0.8*CTE_{P}≤CTE_{C}≤1.2*CTE_{P}, or 0.9*CTE_{P}≤CTE_{C}≤1.1*CTE_{P}, or 0.95*CTE_{P}≤CTE_{C}≤1.05*CTE_{P}.

Exemplary CTEs (measured over a temperature range of about 25-300° C.) for glass materials can range, for example, from about 3×10⁻⁶/° C. to about 11×10⁻⁶/° C., such as from about 4×10⁻⁶/° C. to about 10×10⁻⁶/° C., from about 5×10⁻⁶/° C. to about 8×10⁻⁶/° C., or from about 6×10⁻⁶/° C. to about 7×10⁻⁶/° C., including all ranges and subranges therebetween. Exemplary elastic moduli for glass materials can range from about 50 GPa to about 90 GPa, such as from about 60 GPa to about 80 GPa, or from about 70 GPa to about 75 GPa, including all ranges and subranges therebetween. CTEs for plastic or polymeric materials may range from about 50×10⁻⁶/° C. to about 80×10⁻⁶/° C., such as from about 55×10⁻⁶/° C. to about 75×10⁻⁶/° C., from about 60×10⁻⁶/° C. to about 70×10⁻⁶/° C., including all ranges and subranges therebetween. Exemplary elastic moduli for plastic/polymeric materials can be lower than those of glass, e.g., ranging from about 1.5 GPa to about 3 GPa, such as from about 2 GPa to about 2.5 GPa, including all ranges and subranges therebetween. As such, while the CTE of plastic/polymeric materials may be high as compared to that of glass, a suitable coupling between such materials may still be possible due to the low elastic modulus of the plastic/polymer. In some instances, at least one of the LGP or LCU has an elastic modulus of less than 5 GPa.

With continued reference to FIGS. 1-3, the LGP (110, 210, 310) and/or LCU (120, 220, 320) may comprise any material known in the art for use as components in display devices and other similar devices, e.g., waveguides. For example, the LGP and/or LCU can comprise plastics, such as polymethylmethacrylate (PMMA), polymers, micro-structured (MS) materials, or glasses, to name a few. Exemplary glasses can include, but are not limited to, aluminosilicate, alkali-aluminosilicate, borosilicate, alkali-borosilicate, aluminoborosilicate, alkali-aluminoborosilicate, soda lime, and other suitable glasses. Non-limiting examples of commercially available glasses suitable for use as a glass light guide include, for instance, EAGLE XG®, Lotus™, Willow®, Iris™, and Gorilla® glasses from Coming Incorporated. In yet further embodiments, the LGP can comprise a composite LGP having both glass and plastic, thus, any specific embodiments described herein with reference to only glass LGPs should not limit the scope of the claims appended herewith.

Some non-limiting glass compositions can include between about 50 mol % to about 90 mol % SiO₂, between 0 mol % to about 20 mol % Al₂O₃, between 0 mol % to about 20 mol % B₂O₃, and between 0 mol % to about 25 mol % RₓO, wherein R is any one or more of Li, Na, K, Rb, Cs and x is 2, or Zn, Mg, Ca, Sr or Ba and x is 1, and wherein the glass produces less than or equal to 2 dB/500 mm absorption. In some embodiments, the glass comprises less than 1 ppm each of Co, Ni, and Cr. In some embodiments, the concentration of Fe is <about 50 ppm, <about 20 ppm, or <about 10 ppm. In other embodiments, Fe+30Cr+35Ni<about 60 ppm, Fe+30Cr+35Ni<about 40 ppm, Fe+30Cr+35Ni<about 20 ppm, or Fe+30Cr+35Ni<about 10 ppm. In other embodiments, the composition sheet comprises between about 60 mol % to about 80 mol % SiO₂, between about 0.1 mol % to about 15 mol % Al₂O₃, 0 mol % to about 12 mol % B₂O₃, and about 0.1 mol % to about 15 mol % R₂O and about 0.1 mol % to about 15 mol % RO, wherein R is any one or more of Li, Na, K, Rb, Cs and x is 2, or Zn, Mg, Ca, Sr or Ba and x is 1, and wherein the glass produces less than or equal to 2 dB/500 mm absorption. In some embodiments, the glass produces a color shift less than 0.006, less than 0.005, less than 0.004, or less than 0.003.

In other embodiments, the glass composition can comprise between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂. In some embodiments, the glass can produce a color shift<0.015. In some embodiments, the glass can produce a color shift<0.008, less than 0.005, or less than 0.003.

In additional embodiments, the glass composition can comprise an RₓO/Al₂O₃ ratio between 0.95 and 3.23, wherein R is any one or more of Li, Na, K, Rb, Cs and x is 2. In further embodiments, the glass composition may comprise an RₓO/Al₂O₃ ratio between 1.18 and 5.68, wherein R is any one or more of Li, Na, K, Rb, Cs and x is 2, or Zn, Mg, Ca, Sr or Ba and x is 1. In yet further embodiments, the glass composition can comprise an RₓO—Al₂O₃—MgO between −4.25 and 4.0, wherein R is any one or more of Li, Na, K, Rb, Cs and x is 2. In still further embodiments, the glass composition may comprise between about 66 mol % to about 78 mol % SiO₂, between about 4 mol % to about 11 mol % Al₂O₃, between about 4 mol % to about 11 mol % B₂O₃, between about 0 mol % to about 2 mol % Li₂O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂.

In additional embodiments, the glass composition can comprise between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂. In certain embodiments, the glass composition can comprise between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm.

The LGP and/or LCU may also comprise a glass that has been chemically strengthened, e.g., by ion exchange. During the ion exchange process, ions within a glass sheet at or near the surface of the glass sheet may be exchanged for larger metal ions, for example, from a salt bath. The incorporation of the larger ions into the glass can strengthen the sheet by creating a compressive stress in a near surface region. A corresponding tensile stress can be induced within a central region of the glass sheet to balance the compressive stress.

Ion exchange may be carried out, for example, by immersing the glass in a molten salt bath for a predetermined period of time. Exemplary salt baths include, but are not limited to, KNO₃, LiNO₃, NaNO₃, RbNO₃, and combinations thereof. The temperature of the molten salt bath and treatment time period can vary. It is within the ability of one skilled in the art to determine the time and temperature according to the desired application. By way of a non-limiting example, the temperature of the molten salt bath may range from about 400° C. to about 800° C., such as from about 400° C. to about 500° C., and the predetermined time period may range from about 4 to about 24 hours, such as from about 4 hours to about 10 hours, although other temperature and time combinations are envisioned. By way of a non-limiting example, the glass can be submerged in a KNO₃ bath, for example, at about 450° C. for about 6 hours to obtain a K-enriched layer which imparts a surface compressive stress.

The LGP and/or LCU can, in certain embodiments be transparent or substantially transparent. As used herein, the term “transparent” is intended to denote that the LGP and/or LCU, at a thickness of approximately 1 mm, has a transmittance of greater than about 80% in the visible region of the spectrum (420-750 nm). For instance, an exemplary transparent LGP and/or LCU may have greater than about 85% transmittance in the visible light range, such as greater than about 90%, greater than about 92%, or greater than about 95% transmittance, including all ranges and subranges therebetween. According to various embodiments, the LCU may have a transmittance of less than about 80% in the visible region, such as less than about 70%, less than about 60%, or less than about 50%, including all ranges and subranges therebetween.

In some embodiments, an exemplary transparent LGP and/or LCU can comprise less than 1 ppm each of Co, Ni, and Cr. In some embodiments, the concentration of Fe is <about 50 ppm, <about 20 ppm, or <about 10 ppm. In other embodiments, Fe+30Cr+35Ni<about 60 ppm, Fe+30Cr+35Ni<about 40 ppm, Fe+30Cr+35Ni<about 20 ppm, or Fe+30Cr+35Ni<about 10 ppm. According to additional embodiments, an exemplary transparent LGP and/or LCU can comprise a color shift <0.015 or, in some embodiments, a color shift <0.008.

Color shift may be characterized by measuring the variation in chromaticity coordinate y along length L of a sample using the CIE 1931 standard for color measurements. For glass LGPs, the value of color shift can be reported as Δy=y(L₂)−y(L₁) where L₂ and L₁ are Z positions along the panel or substrate direction away from the source launch and where L₂-L₁=0.5 meters.

According to various embodiments, one or more surfaces of the LGP may be patterned with a plurality of light extraction features, e.g., the light emitting major surface and/or the opposing major surface of the LGP. As used herein, the term “patterned” is intended to denote that the plurality of elements and/or features are present on the surface of the LGP in any given pattern or design, which may, for example, be random or arranged, repetitive or non-repetitive. For instance, in the case of light extraction features, such features may be distributed across the second surface, e.g. as textural features making up a roughened surface.

In various embodiments, the light extraction features present on the surface(s) of the LGP may comprise light scattering sites. For example, the light emitting major surface or opposing major surface of the LGP may be textured, etched, coated, damaged and/or roughened to produce the light extraction features. Non-limiting examples of such methods include, for instance, laser damaging the surface, acid etching the surface, and coating the surface with TiO₂. In certain embodiments, a laser can be used both to cut holes into the LGP and to damage the first and/or second surface to create light extraction features. According to various embodiments, the extraction features may be patterned in a suitable density so as to produce a substantially uniform illumination. The light extraction features may produce surface scattering and/or volumetric scattering of light, depending on the depth of the features in the glass surface. The optical characteristics of these features can be controlled, e.g., by the processing parameters used when producing the extraction features. The LGP may be treated to create light extraction features according to any method known in the art, e.g., the methods disclosed in co-pending and co-owned International Patent Application No. PCT/US2013/063622, incorporated herein by reference in its entirety.

The LCU may be manufactured using any method known in the art of waveguide or light guide processing. For instance, a sheet of material with length L_{C} can be coated with a reflective film on one face and cut into a strip of thickness T_{C} using any variety of apparatuses, e.g., a dicing saw, a wire saw, a laser, to name a few. The cut edges can optionally be polished or any rough surfaces may be filled with an index matching polymer, such as Accuglass T-11 from Honeywell Corp. The LCU and LGP may then be brought into contact and adhered or bonded to each other, e.g., by applying an adhesive between the LGP and LCU, such as a polymer or other conformable material, and/or by heating the materials at a low temperature to form a bond.

The BLUs disclosed herein may be used in various display devices including, but not limited to LCDs or other displays used in the television, advertising, automotive, and other industries. The BLUs disclosed herein may also be used in any suitable lighting applications such as, but not limited to, luminaires or the like.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a light source” includes examples having two or more such light sources unless the context clearly indicates otherwise. Likewise, a “plurality” is intended to denote “more than one.” As such, a “plurality of light sources” includes two or more such light sources, such as three or more, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. As used herein, the term “substantially similar” is intended to denote that two values are approximately equal, e.g., within about 5% of each other, or within about 2% of each other in some cases. For example, in the case of a refractive index of 1.5, a substantially similar refractive index may range from about 1.425 to about 1.575.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprises A+B+C include embodiments where an apparatus consists of A+B+C and embodiments where an apparatus consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

The following Examples are intended to be non-restrictive and illustrative only, with the scope of the invention being defined by the claims.

### EXAMPLES

### Example 1

Exemplary backlight units having a configuration similar to that depicted in FIG. 1 were prepared using a Corning® Iris™ LGP having a refractive index (nₚ) of 1.497 (at 589.3 nm) and a thickness (T_{P}) of 1.1 mm. The light incident surface of the LGP was not chamfered. An LED light source with an active height (H_{L}) of 1.66 mm with Lambertian angular light distribution was positioned 0.1 mm from the LGP. A reflector on the back surface of the LED was a Lambertian reflector with 60% reflectivity, whereas the reflectors on the top and bottom surfaces of the LED were Lambertian reflectors with 96% reflectivity.

The reflecting surface of the LCU was coated with a specular reflect with 96% reflectivity. The refractive index of the LCU was varied from 1.2 to 1.6, the thickness was varied from 0.56 mm to 0.68 mm, and the length was varied from 0.1 mm to 5 mm. The effect of these variations on light coupling efficiency was studied using a ray-tracing model based on Zemax optical modeling software. The light coupled to the LGP was detected at the edge of the LGP opposite the coupler to ensure that only the injected or guided light was detected. The reflectivity of the LED surface itself was determined by measuring a commercial 7040 LED using three lasers with red, green, and blue wavelengths, respectively. Measurement results indicated that the LED surface reflectivity was approximately 60% for all three wavelengths and was unrelated to the LED drive voltage.

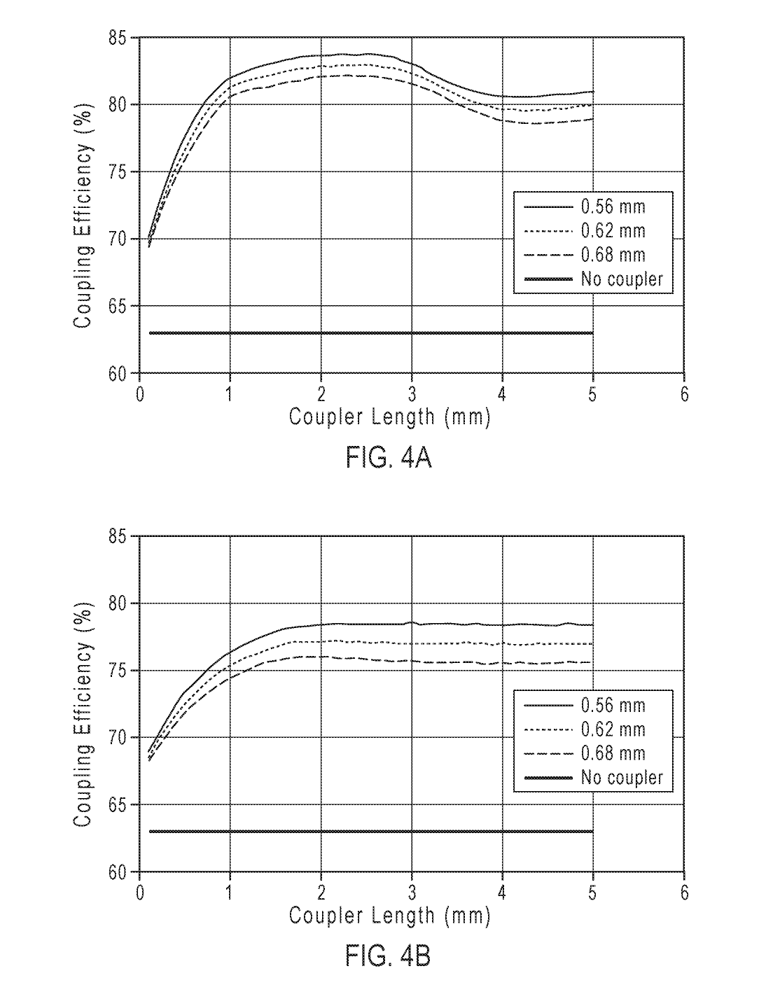

FIG. 4A is a plot of optical coupling efficiency as a function of the length of a LCU having a refractive index (n_{c}) of 1.337 (e.g., n_{c}<nₚ). Optical coupling efficiency without a LCU was approximately 63%, whereas optical coupling efficiency with the LCU ranged from about 70-84%. For example, for an LCU height of 0.56 mm, a coupling efficiency of greater than 83% can be achieved at LCU lengths ranging from 1.4 to 3 mm. As can be appreciated from the plot, light coupling efficiency decreases with increasing coupler thickness (T_{C}). For instance, light coupling efficiency at T_{C}=0.56 (T_{C}+T_{P}=H_{L}) is higher than light coupling efficiency at T_{C}=0.62 or T_{C}=0.68 (T_{C}+T_{P}>H_{L}). Moreover, for the studied LCU thicknesses, optimal light coupling efficiency was observed for an LCU length of about 2.2 mm, whereas light coupling efficiency decreased at LCU lengths greater than 2.6 mm. It is believed that the decrease in coupling efficiency at longer LCU lengths may be due to the coupling of light back into the LCU from the LGP.

FIG. 4B is a plot of optical coupling efficiency as a function of the length of a LCU having a refractive index (n_{c}) of 1.497 (e.g., n_{c}=nₚ). Optical coupling efficiency with these LCUs ranged from about 68-79%, as compared to 70-84% in FIG. 4A (n_{c}<nₚ). As compared to FIG. 4A, it was observed that maximum coupling efficiency dropped about 5%. Similar to FIG. 4A, light coupling efficiency was observed to decrease with increasing coupler thickness (T_{C}). Unlike FIG. 4A, coupling efficiency was observed to level out for LCU lengths greater than 1.6 mm.

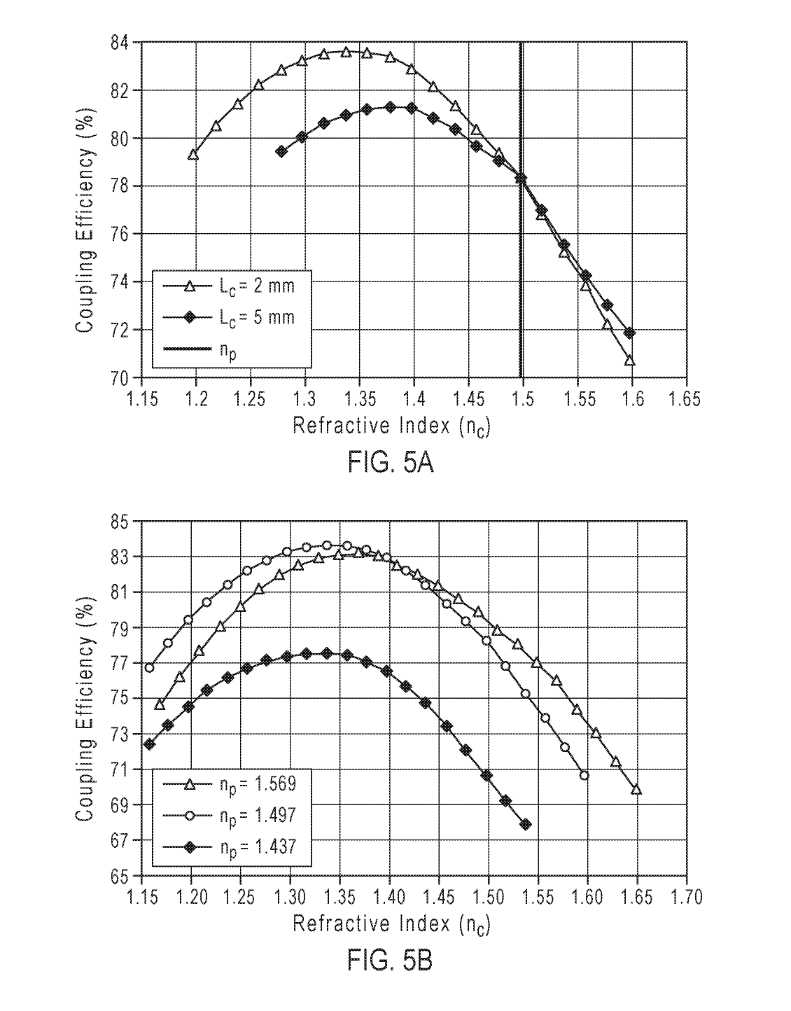

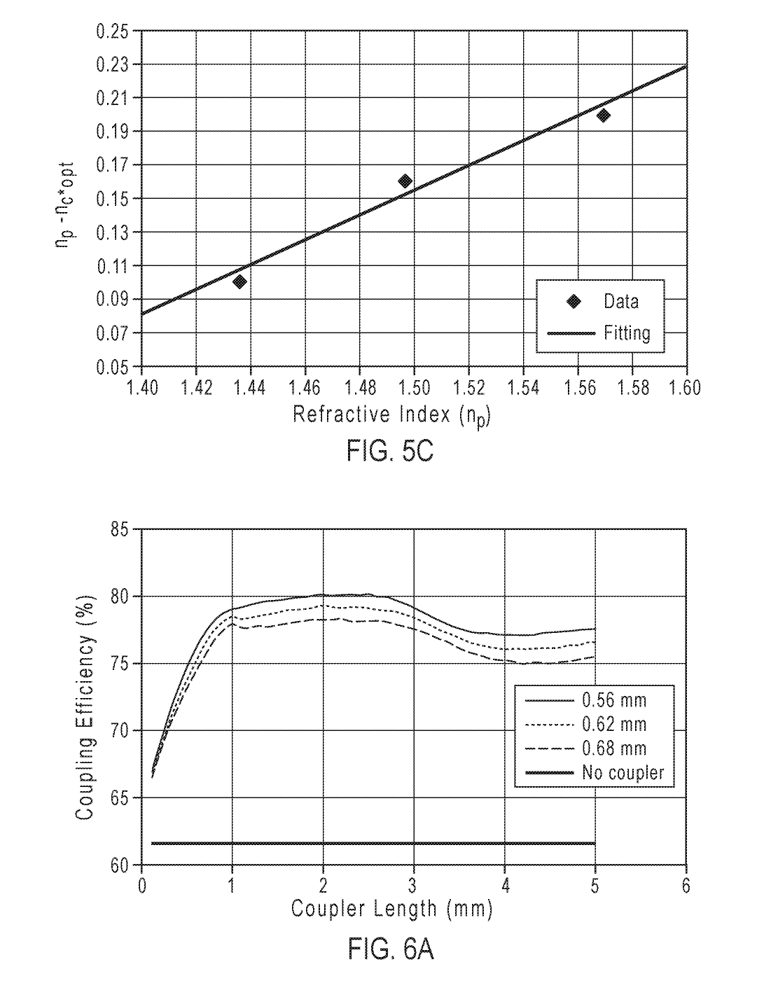

FIG. 5A is a plot of optical coupling efficiency as a function of the refractive index of a LCU having a thickness (T_{C}) of 0.56 (e.g., T_{C}+T_{P}=H_{L}) and a length (L_{C}) of 2 mm or 5 mm. For a LCU length of 2 mm, a maximum coupling efficiency of about 84% was achieved with an LCU refractive index of about 1.34, and a coupling efficiency of greater than 82% was observed for LCU refractive indices ranging from 1.25 to 1.42. As LCU length was increased (L_{C}=5 mm), it was observed that the maximum coupling efficiency was lower and the peak was shifted to higher LCU refractive indices. Furthermore, regardless of coupler length, maximum optical coupling efficiency is reached at a refractive index n_{c} less than that of the LGP and optical coupling efficiency decreases once the refractive index n_{c} approaches and surpasses the refractive index nₚ of the LGP.

FIG. 5B is a plot of optical coupling efficiency as a function of the refractive index of a LCU having a thickness (T_{C}) of 0.56 (e.g., T_{C}+T_{P}=H_{L}) and a length (L_{C}) of 2 mm for LGPs having different refractive indices nₚ. It was observed that the optimal refractive index for the LCU (n_{c*opt}), e.g., the refractive index n_{c} at which maximum light coupling efficiency occurs, was different for LGPs having different refractive indices nₚ. Maximum coupling efficiencies for LGPs with refractive indices of 1.437, 1.497, and 1.569 were achieved with LCU refractive indices of 1.337, 1.3374, and 1.569, respectively. In FIG. 5C, the difference between nₚ and n_{c} (nₚ−n_{c*opt}) was plotted as a function of the refractive index nₚ of the LGP for the data presented in FIG. 5B and fit with a trend line. As can be appreciated by the plot, a relationship exists between nₚ and (nₚ−n_{c*opt}) such that the optimal difference between the refractive indices nₚ and n_{c} increases linearly as the LGP refractive index nₚ increases.

### Example 2

Exemplary backlight units having a configuration similar to that depicted in FIG. 2 were prepared using a Corning® Iris™ LGP having a refractive index (nₚ) of 1.497 (at 589.3 nm) and a thickness (T_{P}) of 1.1 mm. Both corners of the light incident surface of the LGP were chamfered (45° , h=0.1 mm) such that the thickness of the light incident surface t_{P} was 0.9 mm. The LED light source was positioned 0.01 mm from the LGP. All other parameters and models were the same as those described above in Example 1.

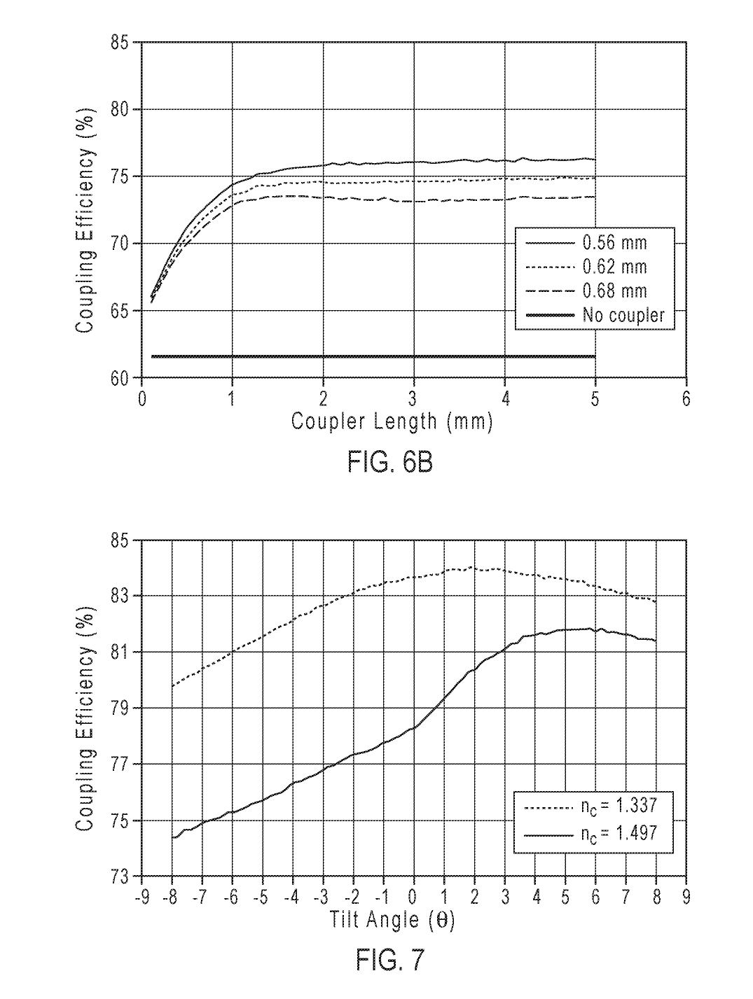

FIG. 6A is a plot of optical coupling efficiency as a function of the length of a LCU having a refractive index (n_{c}) of 1.337 (e.g., n_{c}<nₚ). Optical coupling efficiency without a LCU was approximately 61.6% (as compared to 63% for a non-chamfered LGP in FIG. 4A), whereas optical coupling efficiency with the LCU ranged from about 66-80% (as compared to 70-84% for a non-chamfered LGP in FIG. 4A). The light coupling efficiency curves in FIG. 6A were observed to have the same shape as those of FIG. 4A, but coupling efficiency was, on average, about 3.5% lower than that observed for a non-chamfered LGP, even though the gap between the LED and LGP was smaller for the chamfered LGP. However, for a 0.56 mm thick LCU, greater than 80% coupling efficiency was still observed at LCU lengths ranging from 1.8-2.7 mm. Light coupling efficiency was again observed to decrease with increasing coupler thickness (T_{C}). Optimal light coupling efficiency was observed for an LCU length of about 2.2 mm, whereas light coupling efficiency decreased at LCU lengths greater than 2.6 mm.

FIG. 6B is a plot of optical coupling efficiency as a function of the length of a LCU having a refractive index (n_{c}) of 1.497 (e.g., n_{c}=nₚ). Optical coupling efficiency with these LCUs ranged from about 66-76%, as compared to 66-80% in FIG. 6A (n_{c}<nₚ). As compared to FIG. 5B, optical coupling efficiency was, on average, about 2% lower than that observed for a non-chamfered LGP. Similar to FIG. 6A, light coupling efficiency was observed to decrease with increasing coupler thickness (T_{C}). Unlike FIG. 6A, coupling efficiency was observed to level out for LCU lengths greater than 1.6 mm.

### Example 3

Exemplary backlight units having a configuration similar to that depicted in FIG. 3 were prepared using a Corning® Iris™ LGP having a refractive index (nₚ) of 1.497 (at 589.3 nm) and a thickness (T_{P}) of 1.1 mm. The light incident surface of the LGP was not chamfered. The thickness (T_{C}) of the LCU was 0.56 mm and the length (L_{C}) was 2 mm. The second surface of LCU was not parallel with the light emitting surface of the LGP and the tilt angle (θ) of this was varied from −8° to +8° for units with refractive indices n_{c}=1.377 or 1.497. All other parameters and models were the same as those described above in Example 1.

FIG. 7 is a plot of optical coupling efficiency as a function of tilt angle for LCUs having a refractive index (n_{c}) of 1.337 or 1.497. As the tilt angle was increased from −8° to +8°, it was observed that coupling efficiency varied between 79.8% to 84% for n_{c}=1.337 and between 74.5% and 81.8% for n_{c}=1.497. In general, it was observed that coupling efficiency was greater for positive tilt angles as compared to negative tilt angles. For n_{c}=1.337, maximum coupling efficiency was observed at a tilt angle θ=2°, and for n_{c}=1.497, maximum coupling efficiency was observed at a tilt angle θ=5.5°.

1. A backlight unit comprising:
a light guide plate comprising a light emitting major surface, an opposing major surface, a first light incident edge surface, and an opposing edge surface;
a light coupling unit comprising a second light incident edge surface, an opposing light reflecting edge surface, a first surface, and an opposing second surface;
and at least one light source optically coupled to the first and second light incident edge surfaces,
wherein at least a portion of the first surface of the light coupling unit is in physical contact with at least a portion of the light emitting major surface or opposing major surface of the light guide plate.

2. The backlight unit of claim 1, wherein the light reflecting edge surface of the light coupling unit comprises a reflective film or coating.

3. The backlight unit of claim 1, wherein the at least one light source comprises a reflective film on at least one of a top surface, a bottom surface, and a back surface.

4. The backlight unit of claim 3, wherein the light source comprises a reflective film on each of the top surface, bottom surface, and back surface.

5. The backlight unit of claim 1, wherein a height of the at least one light source is less than or equal to a combined thickness of the light guide plate and the light coupling unit.

6. The backlight unit of claim 1, wherein a length of the light coupling unit is less than 5 mm.

7. The backlight unit of claim 1, wherein the first and second surfaces of the light coupling unit are parallel with the light emitting major surface of the light guide plate.

8. The backlight unit of claim , wherein the first surface and second surface of the light coupling unit are not parallel, and wherein the second surface has a tilt angle ranging from −10° to 10°.

9. The backlight unit of claim 1, wherein the first light incident edge surface of the light guide plate is chamfered.

10. The backlight unit of claim 9, wherein the chamfer angle ranges from about 10° to about 60°.

11. The backlight unit of claim 1, wherein a refractive index of the light guide plate (nₚ) is different from a refractive index of the light coupling unit (n_{c}).

12. The backlight unit of claim 11, wherein nₚ is greater than n_{c}.

13. The backlight unit of claim 11, wherein 0.25nₚ+0.77≤n_{c}≤0.25n_{P}+1.18.

14. The backlight unit of claim 1, wherein a difference between a coefficient of thermal expansion of the light coupling unit and a coefficient of thermal expansion of the light guide plate is less than 30%.

15. The backlight unit of claim 1 wherein a modulus of elasticity of at least one of the light guide plate or light coupling unit is less than 5 GPa.

16. The backlight unit of claim 1, wherein at least one of the light guide plate and the light coupling unit comprises a glass, glass-ceramic, plastic, or polymeric material.

17. The backlight unit of claim 1, wherein at least one of the light guide plate and the light coupling unit have an optical transmission of at least about 80% at a visible wavelength ranging from about 420 nm to about 750 nm.

18. A backlight unit comprising:
a light guide plate comprising a light emitting major surface, an opposing major surface, and a first light incident edge surface;
a light coupling unit in physical contact with at least a portion of the light emitting major surface or opposing major surface of the light guide plate, the light coupling unit comprising a second light incident edge surface and an opposing light reflecting edge surface;
at least one light source optically coupled to the first and second light incident edge surfaces; and
a light recycling cavity defined by the light reflecting edge surface of the light coupling unit and a reflective film on each of a top, bottom, and back surfaces of the light source.

19. An electronic device, display device, or lighting device comprising the backlight unit of claim 1 or 18.
